(19) United States
(12) Patent Application Publication
(10) Pub. No.: US 2012/0072953 A1
(43) Pub. Date: Mar. 22, 2012

(54) METHOD AND DEVICE FOR REVEALING IMAGES OBSCURED BY A PROGRAM GUIDE IN ELECTRONIC DEVICES

(75) Inventors: BEAU JAMES, San Diego, CA (US); Michael B. Hirsch, San Diego, CA (US)

(73) Assignee: QUALCOMM Incorporated, San Diego, CA (US)

(21) Appl. No.: 12/888,249

(22) Filed: Sep. 22, 2010

(51) Int. Cl. H04N 5/445; G06F 3/041

(52) U.S. Cl. 725/52; 345/173

(57) ABSTRACT

Methods and devices enable users of electronic devices to temporarily move a program guide to view an underlying image by executing a recognizable touch movement on a touchscreen display. When a program guide or other menu is activated, a processor of the device may monitor touches to the display for recognizable movements, such as horizontal, linear or other shaped paths. Upon recognizing a touch event movement that corresponds to the program guide hide function, the processor may cause the program guide to slide to the left, right, up or down, or to disappear in order to reveal the underlying video program. When the device processor detects an end to the touch event, the processor returns the program guide to its original position on the display. Movements of the program guide may be animated on the display. The devices may be mobile television receivers and the video may be broadcast programs.

### BACKGROUND

Wireless communication technologies have seen explosive growth over the past few years. This growth has been fueled by wireless services providing freedom of movement to the mobile public, and cutting the tether to hardwired communication systems. A recent addition to wireless communication services has been mobile television systems that broadcast television programming and other content to handheld and mobile receiver devices. Mobile television broadcast services allow users to view multimedia programming, such as television shows, as well as receive mobile editions of news, entertainment, sports, business, and other broadcast programming, using mobile receiver devices configured to receive the mobile broadcast transmissions.

In order to permit users to discover programming that is available and to select programming for viewing, mobile television receiver devices typically are configured to provide a program guide that serves as a user interface for program selection. Typical program guides used in mobile television receiver devices list available programming and broadcast times in a scrollable table presented on the display. Users may scroll through the listing of program materials until they find one of interest, and then select the program for viewing, such as by single or double tapping on program listing on a touchscreen display. While convenient, program guides may block the display when they are activated, preventing users from seeing a video program that is currently playing.

### SUMMARY

The various embodiments provide methods and devices enabling viewers of mobile broadcast television receiver devices to conveniently move a program guide off of the display in order to view an underlying video program. The various embodiments may be enabled on receiver devices equipped with touchscreen displays. When a program guide is activated while a video program is being presented, a processor of the receiver device may monitor touches to the display for movement that matches a pattern associated with the function of hiding or repositioning the program guide. Such a pattern may be one that is distinct from interactions with the program guide itself. Upon detecting a movement on the touchscreen display that matches a pattern associated with hiding of the program guide, which may involve disambiguating the movement from program guide user interface inputs, the receiver device processor may cause the program guide to slide to the left or right, or up or down to an edge of the display, or to temporarily disappear to reveal the underlying video program. When the device processor detects an end to the touch event (i.e., the user lifts his or her finger off of the touchscreen display), the processor returns the program guide to its original position on the display. Movements of the program guide may be animated.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIGS. 1A-1E are illustrations of a mobile receiver device showing functionality of the various embodiments.

FIG. 2 is a process flow diagram of a method for implementing the various embodiments.

FIG. 3 is a component block diagram of a receiver device suitable for use with the various embodiments.

FIG. 4 is a perspective view of a receiver device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device,” “mobile broadcast television receiver device” and “receiver device” are used interchangeably herein to refer to any one or all of mobile media broadcast receivers, cellular telephones, personal television devices, personal data assistants (PDA's), palm-top computers, wireless electronic mail receivers (e.g., the Blackberry® and Treo® devices), multimedia Internet enabled cellular telephones (e.g., the Blackberry Storm® and Apple iPhone®), Global Positioning System (GPS) receivers, wireless gaming controllers, receivers within vehicles (e.g., automobiles) and similar personal electronic devices which include a programmable processor and memory and the capability of displaying video material and a menu or program guide.

The term “program guide” is used herein to refer generally to menu applications and displays implemented on mobile devices and receiver devices that present information to users. In a preferred embodiment, the program guide is a menu display listing programs that are available for viewing on a mobile television receiver device. However, the embodiments are useful with and applicable to a variety of menu applications and displays.

The program guide functionality provided in typical mobile broadcast receiver devices suffers from an annoying disadvantage; namely that it blocks the display of any ongoing video program. Thus, if a user wants to check a program listing (e.g., to determine the next program on the broadcast schedule) while watching a live television broadcast, the user has to stop watching the video so long as the program guide is displayed. This can impact the user's experience.

The various embodiments overcome this limitation of current program guides by providing a mechanism that enables users to easily slide the program guide to the side or cause it to temporarily disappear using an intuitive touch gesture executed on a touchscreen display. In an embodiment, when the receiver device is playing a video program and the program guide is activated (i.e., presented on the display), a processor of the receiver device may monitor the touchscreen display to detect a touch event. A touch event refers to the processing that occurs when a user touches a touchscreen display. When a touch event is detected, the processor may monitor the position and movement of the location of the touch on the touchscreen surface to determine whether it follows a path or pattern of movement that the processor recognizes to be associated with the program guide hide function, such as a horizontal path with respect to the axes of the display. Such a path or pattern of movement may be one that is distinct from normal user interactions with the program guide itself, such as touch gestures for scrolling the program guide list or selecting a particular program for information or viewing. As part of recognizing a program guide hide function movement pattern, the processor may compare the movement to a stored pattern or template for sufficient time or distance to confirm the movement matches the pattern, thus disambiguating the movement from other program guide user interface commands. If the processor determines that the touch event does not follow a recognized path (e.g., a left or right sliding motion), the processor may implement other commands associated with the program guide user interface. For example, if the touch event is a single tap or double tap, the processor may implement or activate a particular menu option. As another example, if the touch event follows a vertical path, the program guide may be scrolled in the direction of the movement.

If a recognized movement associated with the program guide hide function is detected (e.g., a horizontal movement greater than a threshold distance) the processor may modify the display to reveal the underlying video program, such as by sliding the program guide to the left or right edge, or top or bottom edge, or causing it to temporarily disappear. This movement or temporary hiding of the program guide may be animated, or follow the user's finger touch on the display.

The processor may maintain the display configured with the program guide positioned to one side or not visible and the underlying video program visible for as long as the user's finger remains in contact with the touchscreen display. When the processor detects the end of the touch event, such as when the user lifts his or her finger from the touchscreen surface, the processor may regenerate the display of the program guide, once again hiding the video program. This return of the program guide to the forefront of the display may be accomplished immediately or with the use of animation, such as sliding the program guide back into place.

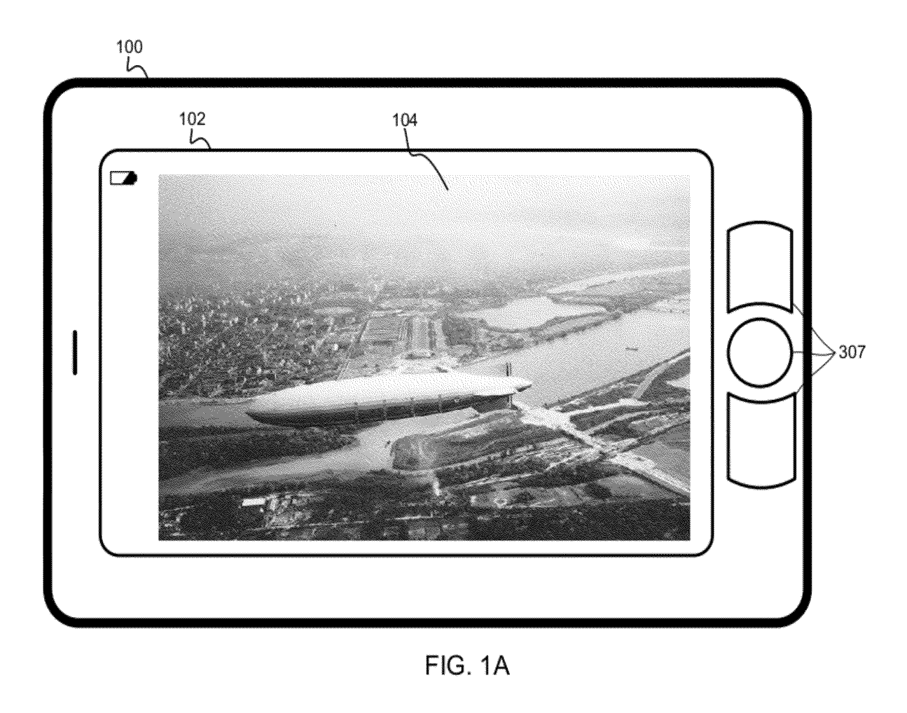

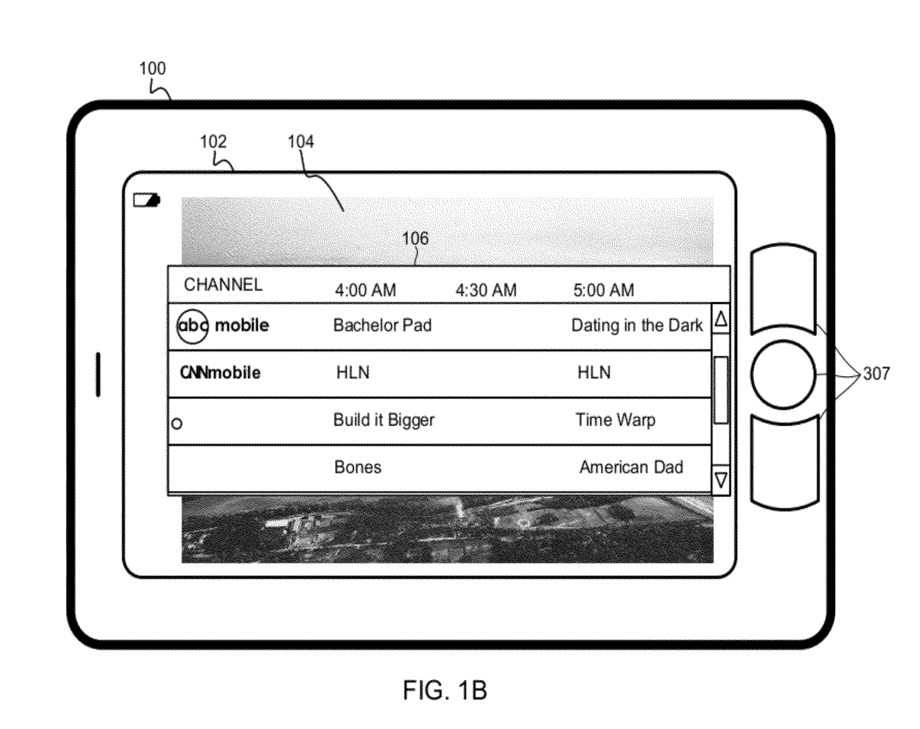

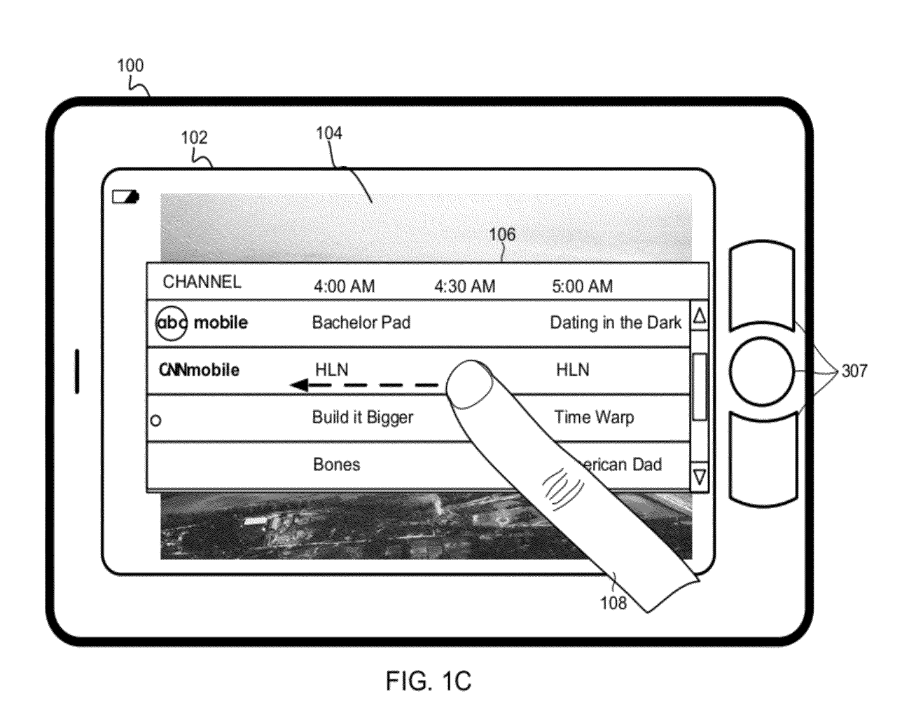

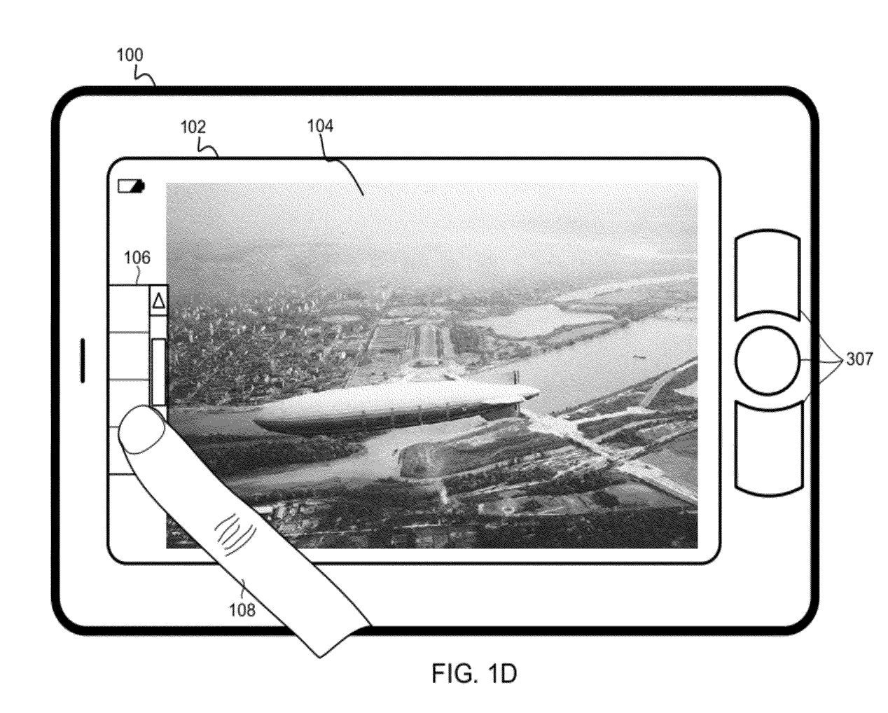

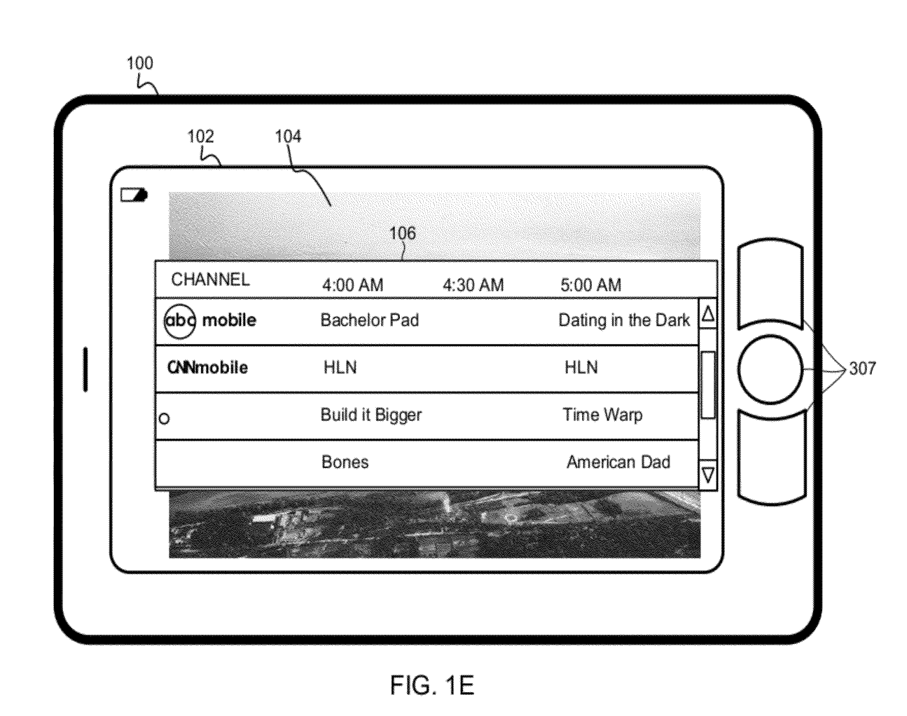

FIG. 1A through 1E illustrate functionality of the embodiments on a representative mobile television receiver device. Referring to FIG. 1A, a receiver device 100 typically includes a touchscreen display 102 on which is playing a video program 104. Referring to FIG. 1B, when the user activates the program guide 106, it will block the video program 104 as illustrated. Referring to FIG. 1C, when the user touches the touchscreen display 102 (e.g., with a finger 108), the device processor monitors the touch location to detect whether it moves horizontally (for example) as indicated by the dashed arrow. Referring to FIG. 1D, when the processor detects that the touch event is a horizontal sliding motion (for example), the processor modifies the display to reposition the program guide 106 off of the display area (or remove the program guide from the displayed image) to reveal most if not all of the underlying video program 104. Referring to FIG. 1E, when the user lifts his or her finger 108 from the touchscreen display 102, the program guide 106 is returned to the center of the display 102.

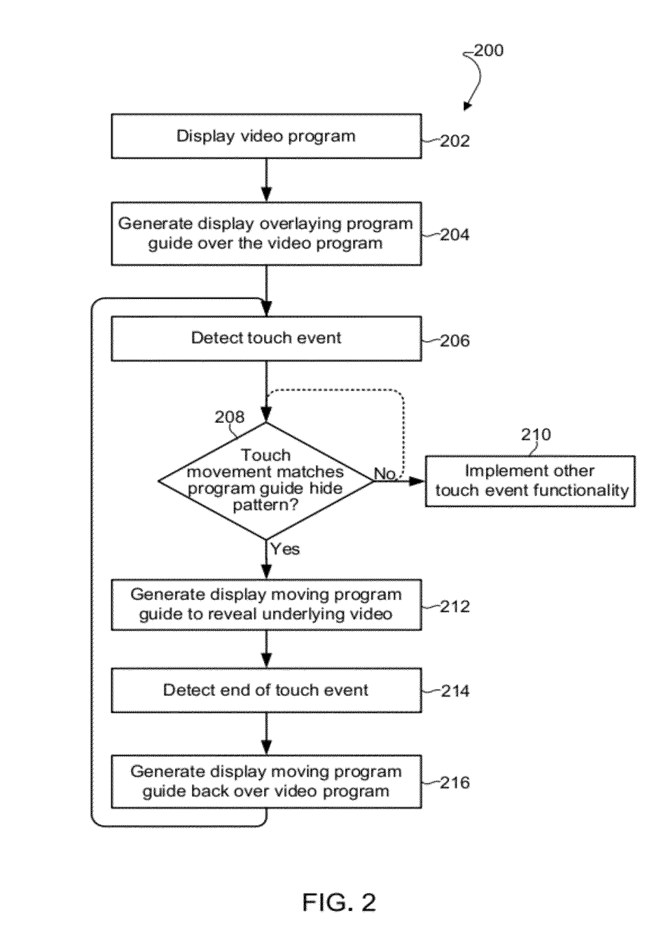

FIG. 2 illustrates a method 200 that may be implemented in a processor of a receiver device to accomplish the functionality of the various embodiments. At the start of method 200 in step 202, the receiver device processor may be displaying a video program. In step 204, the processor may receive a user input requesting display of the program guide, and generate a display including the program guide in response. In some implementations the processor may automatically generate the program guide (or other menu display) in step 204, such as in response to an alarm or user programming of the receiver device (e.g., as a reminder to tune in to a favorite TV program at its scheduled broadcast time). In step 206, the processor may detect a touch event (i.e., a user touch on the touchscreen display), such as in the form of a signal received from the touchscreen touch sensor circuitry. The processor may then monitor the location of the touch event (i.e., where the user is touching the touchscreen surface) over time in determination step 208 to determine whether the touch event is moving in a manner that matches a pattern associated with the program guide hiding functionality. For example, the processor may monitor the touch event movement to determine whether it is moving linearly, such as right or left in a horizontal motion.

The pattern associated with the program guide hide function that is compared to a touch event movement in determination step 208 may be predefined or user definable, and may be stored in memory of the device. In determining whether the touch event is moving in a horizontal (or vertical) direction in determination step 208, the processor may perform various disambiguating operations to distinguish the movement from other user input gestures associated with the program guide or other device functions. For example, the device processor may compare the detected movement of the touch across the display to a first threshold distance, and not conclude it matches the hide function movement pattern (e.g., it is a horizontal (or vertical) movement) or otherwise act on the touch event unless or until the touch event movement exceeds that threshold distance. This comparison to a threshold distance may avoid misinterpreting inadvertent minor movements of the user's finger on the touchscreen surface. Further, the process of disambiguating the touch event in determination step 208 may compare the path traced by the touch event to particular distinguishing elements in the hide function movement pattern, such as a horizontal (vs. vertical) movement, a characteristic change in direction (e.g., a corner of a triangle, square or checkmark, or a circular arch), a characteristic speed (e.g., slower than a flick gesture), etc. Also, the hide function movement pattern may involve one or more taps or a pattern of taps (e.g., a triple tap or a series of taps according to a drum rhythm) which may be combined with a movement pattern (e.g., a tap and slide pattern, a slide and tap pattern, a swirl and tap pattern, etc.). The nature of the disambiguation process in determination step 208 may depend both on the hide function movement pattern and patterns associated with normal program guide interactions, as well as other user inputs to the receiver device.

If the processor determines that the touch event is not recognized to be a movement associated with the program guide hide function (e.g., a horizontal movement) (i.e., determination step 208=“No”), the processor may act on the touch event using other standard user interface commands or routines associated with the program guide display in step 210. For example, such other actions may be to scroll the list of programs in the program guide, to select a program for viewing or more information, or to close the program guide. The processor may also continue to monitor movements of the touch event by returning to determination step 208.

If the processor determines that the touch event is following a path recognized to match a movement associated with the program guide hide function (e.g., a horizontal movement) (i.e., determination step 208=“Yes”), the processor may regenerate or modify the display to reveal the underlying video program in step 212, such as by temporarily removing the program guide or repositioning the program guide to an edge of the display (i.e., left, right, top or bottom of the display). This temporary removal or repositioning of the program guide in step 212 may be animated, such as to show the program guide slowly fading away or sliding slowly to an edge of the display. Other forms of animation may also be implemented, such as swirling to a point like it is going down the drain, peeling or rolling in a direction as if a cover sheet is being peeled or rolled back to reveal the underlying video, splitting apart, or other animations.

In an embodiment, as part of step 212 the program guide may be repositioned so as to follow the movement of the user's finger as it moves across the touchscreen display, such as to follow it to one margin or the other. In a further embodiment, as part of step 212 the processor may generate displays that move the program guide so as to follow movement of the user's finger across the touchscreen display until the movement exceeds a second threshold distance, at which point the program guide may be immediately moved the rest of the way to the edge of, or be temporarily removed from, the display.

In generating a display in which the program guide is positioned off to one side of the display (i.e., left, right, top or bottom of the display) or temporarily removed from the display in step 214, the processor may maintain the program guide image data in a video buffer memory to enable rapid regeneration of the program guide image in the same configuration (e.g., showing the same position within the program list). Alternatively, the processor may store state information regarding the program guide (e.g., a current location in the program list) to enable the program guide image to be regenerated when these touch event ends.

While the processor displays the underlying video with the program guide positioned off to the side display (i.e., left, right, top or bottom of the display) or out of the view, the processor may monitor the touchscreen to detect when the user's finger is no longer in contact with the surface in step 214. When the processor detects that the touch event has ended in step 214, the processor may regenerate the display of the program guide in the ordinary manner (i.e., covering the video program) in step 216 as illustrated in FIG. 1E. This regeneration of the program guide display may include animation, such as sliding the program guide back into view. Thereafter, the processor may continue displaying the program guide while monitoring for a new touch to the touchscreen by returning to step 206.

Since the various embodiments offer a convenient way for users to view the underlying program video program without having to suspend the program guide which could cause them to lose their place in the programming list, the embodiments are of particular benefit to small television devices, such as personal television players. In such small receiver devices, there is insufficient display area to position a program guide alongside of the video program, even if the video is reformatted as a thumbnail version. Thus the embodiments present an improvement over previous program guide services provided for conventional (i.e., large screen) televisions that permit users to view the ongoing video program in a window box or side by side with the program guide.

In a further embodiment, the functionality of temporarily moving or removing the program guide from the display in response to recognizing the movement of a touch event may be implemented only when a video program is playing (step 202) and the program guide is displayed (step 204). Receiver device processors may be configured such that when these two conditions are not met, recognized movements of touch events do not activate the operations described above with reference to FIG. 2. In this manner, when a video is not playing or the program guide is not displayed the movements associated with the program guide hide function (e.g., swipes and flicks) may be used for or correspond to other types of user interface commands, such as changing channels, fast forwarding or rewinding a video program, selecting a different file, or even activating the program guide.

While the various embodiments are described with reference to a horizontal movement of a touch event being the recognizable movement pattern associated with the program guide hide function, the functionality may likewise be implemented in response to detecting any linear movement (e.g., a vertical or diagonal movement), a triple (or more) tap, a particular virtual or hard key button press, or any recognizable path or shape that is distinguishable from a user interface gesture (or button press) associated with interacting with the program guide. Examples of recognizable paths or shapes that may be associated with the program guide hide function include a horizontal line, a vertical line, a straight line exceeding a first threshold distance, a circle, a triangle, a square, a checkmark, a variety of multi-touch gestures (e.g., a two-finger swipe), etc. Such path shapes may be predefined (e.g., by the OEM) or user defined, such as by using a training routine, and may be stored in memory for comparison to the path traced by the touch event on the touchscreen display. Thus, references to a horizontal movement are for example purposes, and are not intended to limit the scope of the claims except as explicitly recited in the claim elements.

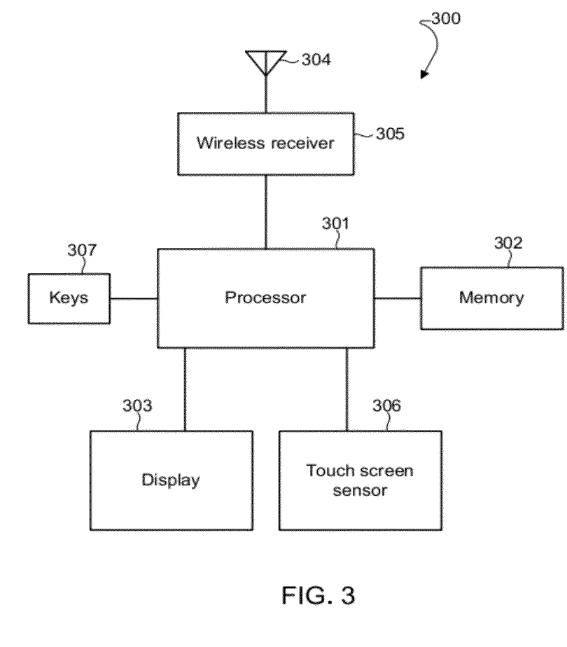

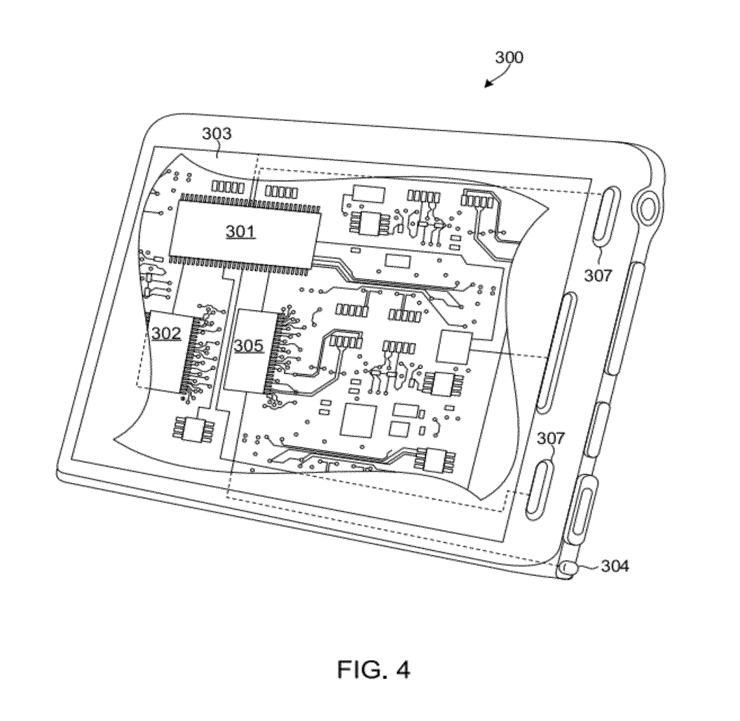

The embodiments may be implemented in a variety of mobile television receiver devices, representative examples of which are illustrated in FIGS. 3 and 4. FIG. 3 is a circuit block diagram of a representative receiver device 300, and FIG. 4 shows a perspective view of such a receiver device.

Referring to FIGS. 3 and 4 together, a receiver device 300 includes a processor 301 which is coupled to memory 302 and a display 303. The receiver device 300 may also include an antenna 304 coupled to a mobile television broadcast receiver circuit 305 which is coupled to the processor 301. The receiver circuitry 305 may be any known mobile television receiver circuit, such as mobile television technology circuits configured to receive broadcasts according to one or more known mobile television formats, including Open Mobile Alliance Mobile Broadcast Services Enabler Suite (OMA BCAST), MediaFLO®, Digital Video Broadcast IP Datacasting (DVB-IPDC), Digital Video Broadcasting-Handheld (DVB-H), Digital Video Broadcasting-Satellite services to Handhelds (DVB-SH), Digital Video Broadcasting-Handheld 2 (DVB-H2), Advanced Television Systems Committee-Mobile/Handheld (ATSC-M/H), Integrated Services Digital Broadcasting-Terrestrial (ISDB-T), and China Multimedia Mobile Broadcasting (CMMB). The various embodiments may also be applicable to receiver devices that receive video content from other sources, including, for example, the Internet, over a cellular telephone network, a WiFi wireless communication network, a WiMax wireless communication network, a 3GPP Long Term Evolution (LTE) communication network, etc.

In a preferred embodiment, the display 303 may be a touchscreen display, in which case the display may include a touchscreen sensor 306 that is physically coupled to the display surface and electrically coupled to the processor 301. Any known type of touchscreen display 303, 306 may be implemented in the various embodiments.

While the various embodiments are described above with reference to receiver devices configured with touch screen displays, the embodiments may also be implemented on receiver devices that use physical buttons for receiving user inputs. In such a case, the receiver device 300 may include physical buttons 307 as illustrated in FIGS. 3 and 4. Referring to FIG. 2, in such implementations, a user press of a button may be detected by the processor in step 206 (instead of a touchscreen touch event). In the case of a button press detected in step 206, the processor may determine whether the pressed button is associated with a function to hide the program guide (e.g., a left or right arrow key) in determination step 208. If the processor determines that a key associated with hiding the program guide has been pressed (i.e., determination step 208=“Yes”), the processor may hide or reposition the program guide to one side of the display to reveal the underlying video program. In this embodiment, instead of detecting an end of a touch event on the touchscreen in step 214, the processor may wait for a second button press in step 214. In response to detecting a second button press, the processor may regenerate the program guide (or other menu) display in step 216. As with the other embodiments described above, the program guide status may be stored in memory, such as an image stored in a video buffer or as state values that will enable the processor to present the program guide in the same state (e.g., at the same point in a list of menu items) when it is returned to the display in step 216.

While the various embodiments are described above with reference to mobile television receiver devices, the embodiments may also be implemented on other types of mobile devices that display video programs and include a menu application that covers the video program when displayed. For example, the embodiments may be implemented in a portable DVD player that includes a menu option which may be displayed while the underlying video program continues to play. Such a DVD player would include many of the same circuit components as illustrated in FIGS. 3 and 4, with the possible exception of the antenna 304 and receiver circuitry 305. As another example, the embodiments may be implemented on a mobile telephone, such as a smart phone, which may be configured to play video material, such as Internet content, live video feeds, stored video, multimedia message system (MMS) material, etc. In such an implementation, the program guide may be a smart phone menu or catalogue of stored content. A smart phone or similar mobile device implementing the various embodiments would include the same components as illustrated in FIGS. 3 and 4 with the addition of cellular telephone transceiver circuitry (not shown) coupled to the processor 301 and the antenna 304. Other examples of electronic devices that may implement the various embodiments include, but are not limited to, Portable gaming devices, tablet computers, smartbooks, netbooks, iPads, laptop computers, portable navigation devices and other electronic devices that receive content (especially video content) and receiver user inputs to view a menu interface.

The processors 301 may be any programmable microprocessor, microcomputer or multiple processor chip or chips that can be configured by software instructions (applications) to perform a variety of functions, including the functions of the various embodiments described below. In some mobile receiver devices, multiple processors 301 may be provided, such as one processor dedicated to wireless communication functions and one processor dedicated to running other applications. Typically, software applications may be stored in the internal memory 302 before they are accessed and loaded into the processor 301. The processor 301 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A user interface method for use on an electronic device having a touchscreen display and configured to display visual media and a program guide, comprising:
detecting a touch event on the touchscreen display when the program guide is displayed;
determining whether the touch event is moving in a manner that matches a pattern associated with hiding the program guide; and
repositioning a display of the program guide to reveal another image when the touch event is determined to match a pattern associated with hiding the program guide.

2. The method of claim 1, wherein determining whether the touch event is moving in a manner that matches a pattern associated with hiding the program guide comprises:
comparing movement of the touch event to a first threshold distance; and
determining whether the touch event is moving in a manner that matches a pattern associated with hiding the program guide when the movement of the touch event exceeds the first threshold distance.

3. The method of claim 1, wherein determining whether the touch event is moving in a manner that matches a pattern associated with hiding the program guide comprises determining whether the touch event is moving along a path selected from the group of a horizontal line, a vertical line, a straight line exceeding a first threshold distance, a circle, a triangle, a square, a checkmark, and multi-touch events.

4. The method of claim 1, wherein determining whether the touch event is moving in a manner that matches a pattern associated with hiding the program guide comprises determining whether the touch event is moving in a manner that matches a user defined pattern stored in memory.

5. The method of claim 1, wherein repositioning a display of the program guide to reveal another image comprises moving the program guide to an edge of the display and displaying the other image.

6. The method of claim 1, wherein repositioning a display of the program guide to reveal another image comprises removing the program guide from the display and displaying the other image.

7. The method of claim 1, wherein the other image is a video program.

8. The method of claim 1, further comprising determining whether a video program is playing on the electronic device, wherein repositioning a display of the program guide is accomplished only if a video program is playing and the program guide is displayed.

9. The method of claim 1, wherein repositioning a display of the program guide to reveal another image comprises:
comparing a movement distance of the touch event to a second threshold distance;
moving the program guide on the display consistent with movement of the touch event so long as the touch event movement distance does not exceed the second threshold distance; and
repositioning the display of the program guide to reveal the other image when the touch event movement distance exceeds the second threshold distance.

10. The method of claim 1, wherein repositioning a display of the program guide to reveal another image comprises animating the repositioning of the display of the program guide.

11. The method of claim 1, wherein determining whether the touch event is moving in a manner that matches a pattern associated with hiding the program guide comprises disambiguating the touch event from user input gestures associated with other program guide functionality.

12. The method of claim 1, further comprising:
determining when the detected touch event ends; and
returning the program guide to its original position in the display when the touch event ends.

13. The method of claim 12, wherein returning the program guide to its original position in the display comprises animating movement of the program guide back to its original position in the display.

14. A mobile receiver device, comprising:
a processor;
a touchscreen display coupled to the processor,
wherein the processor is configured with processor-executable instructions to perform operations comprising:
detecting a touch event on the touchscreen display when a program guide is displayed;
determining whether the touch event is moving in a manner that matches a pattern associated with hiding the program guide; and
repositioning a display of the program guide to reveal another image when the touch event is determined to match a pattern associated with hiding the program guide.

15. The mobile receiver device of claim 14, wherein the processor is configured with processor-executable instructions to perform operations such that determining whether the touch event is moving in a manner that matches a pattern associated with hiding the program guide comprises:
comparing movement of the touch event to a first threshold distance; and
determining whether the touch event is moving in a manner that matches a pattern associated with hiding the program guide when the movement of the touch event exceeds the first threshold distance.

16. The mobile receiver device of claim 14, wherein the processor is configured with processor-executable instructions to perform operations such that determining whether the touch event is moving in a manner that matches a pattern associated with hiding the program guide comprises determining whether the touch event is moving along a path selected from the group of a horizontal line, a vertical line, a straight line exceeding a first threshold distance, a circle, a triangle, a square, a checkmark, and multi-touch events.

17. The mobile receiver device of claim 14, wherein the processor is configured with processor-executable instructions to perform operations such that determining whether the touch event is moving in a manner that matches a pattern associated with hiding the program guide comprises determining whether the touch event is moving in a manner that matches a user defined pattern stored in memory.

18. The mobile receiver device of claim 14, wherein the processor is configured with processor-executable instructions to perform operations such that repositioning a display of the program guide to reveal another image comprises moving the program guide to an edge of the display and displaying the other image.

19. The mobile receiver device of claim 14, wherein the processor is configured with processor-executable instructions to perform operations such that repositioning a display of the program guide to reveal another image comprises removing the program guide from the display and displaying the other image.

20. The mobile receiver device of claim 14, wherein the processor is configured with processor-executable instructions to perform operations such that the other image is a video program.

21. The mobile receiver device of claim 14, wherein the processor is configured with processor-executable instructions to perform operations further comprising determining whether a video program is playing on the electronic device, wherein repositioning a display of the program guide is accomplished only if a video program is playing and the program guide is displayed.

22. The mobile receiver device of claim 14, wherein the processor is configured with processor-executable instructions to perform operations such that repositioning a display of the program guide to reveal another image comprises:
comparing a movement distance of the touch event to a second threshold distance;
moving the program guide on the display consistent with movement of the touch event so long as the touch event movement distance does not exceed the second threshold distance; and
repositioning the display of the program guide to reveal the other image when the touch event movement distance exceeds the second threshold distance.

23. The mobile receiver device of claim 14, wherein the processor is configured with processor-executable instructions to perform operations such that repositioning a display of the program guide to reveal another image comprises animating the repositioning of the display of the program guide.

24. The mobile receiver device of claim 14, wherein the processor is configured with processor-executable instructions to perform further operations such that determining whether the touch event is moving in a manner that matches a pattern associated with hiding the program guide comprises disambiguating the touch event from user input gestures associated with other program guide functionality.

25. The mobile receiver device of claim 14, wherein the processor is configured with processor-executable instructions to perform further operations comprising:
determining when the detected touch event ends; and
returning the program guide to its original position in the display when the touch event ends.

26. The mobile receiver device of claim 25, wherein the processor is configured with processor-executable instructions to perform operations such that returning the program guide to its original position in the display comprises animating movement of the program guide back to its original position in the display.

27. A mobile receiver device, comprising:
means for detecting a touch event on a touchscreen display when a program guide is displayed;
means for determining whether the touch event is moving in a manner that matches a pattern associated with hiding the program guide; and
means for repositioning a display of the program guide to reveal another image when the touch event is determined to match a pattern associated with hiding the program guide.

28. The mobile receiver device of claim 27, wherein means for determining whether the touch event is moving in a manner that matches a pattern associated with hiding the program guide comprises:
means for comparing movement of the touch event to a first threshold distance; and
means for determining whether the touch event is moving in a manner that matches a pattern associated with hiding the program guide when the movement of the touch event exceeds the first threshold distance.

29. The mobile receiver device of claim 27, wherein means for determining whether the touch event is moving in a manner that matches a pattern associated with hiding the program guide comprises means for determining whether the touch event is moving along a path selected from the group of a horizontal line, a vertical line, a straight line exceeding a first threshold distance, a circle, a triangle, a square, a checkmark, and multi-touch events.

30. The mobile receiver device of claim 27, wherein means for determining whether the touch event is moving in a manner that matches a pattern associated with hiding the program guide comprises means for determining whether the touch event is moving in a manner that matches a user defined pattern stored in memory.

31. The mobile receiver device of claim 27, wherein means for repositioning a display of the program guide to reveal another image comprises means for moving the program guide to an edge of the display and displaying the other image.

32. The mobile receiver device of claim 27, wherein means for repositioning a display of the program guide to reveal another image comprises means for removing the program guide from the display and displaying the other image.

33. The mobile receiver device of claim 27, wherein means for repositioning a display of the program guide to reveal another image comprises means for repositioning the display of the program guide to reveal a video program.

34. The mobile receiver device of claim 27, further comprising means for determining whether a video program is playing on the electronic device, wherein repositioning a display of the program guide is accomplished only if a video program is playing and the program guide is displayed.

35. The mobile receiver device of claim 27, wherein means for repositioning a display of the program guide to reveal another image comprises:
means for comparing a movement distance of the touch event to a second threshold distance;
means for moving the program guide on the display consistent with movement of the touch event so long as the touch event movement distance does not exceed the second threshold distance; and
means for repositioning the display of the program guide to reveal the other image when the touch event movement distance exceeds the second threshold distance.

36. The mobile receiver device of claim 27, wherein means for repositioning a display of the program guide to reveal another image comprises means for animating the repositioning of the display of the program guide.

37. The mobile receiver device of claim 14, wherein means for determining whether the touch event is moving in a manner that matches a pattern associated with hiding the program guide comprises means for disambiguating the touch event from user input gestures associated with other program guide functionality.

38. The mobile receiver device of claim 27, further comprising:
means for determining when the detected touch event ends; and
means for returning the program guide to its original position in the display when the touch event ends.

39. The mobile receiver device of claim 38, wherein means for returning the program guide to its original position in the display comprises means for animating movement of the program guide back to its original position in the display.

40. A non-transitory processor-readable storage medium having stored thereon processor-executable instructions configured to cause a processor of a mobile receiver device to perform operations comprising:
detecting a touch event on a touchscreen display when a program guide is displayed;
determining whether the touch event is moving in a manner that matches a pattern associated with hiding the program guide; and
repositioning a display of the program guide to reveal another image when the touch event is determined to match a pattern associated with hiding the program guide.

41. The non-transitory computer-readable storage medium of claim 40, wherein the stored processor-executable instructions are configured to cause the processor to perform operations further comprising:
comparing movement of the touch event to a first threshold distance; and
determining whether the touch event is moving in a manner that matches a pattern associated with hiding the program guide when the movement of the touch event exceeds the first threshold distance.

42. The non-transitory computer-readable storage medium of claim 40, wherein the stored processor-executable instructions are configured to cause the processor to perform operations such that determining whether the touch event is moving in a manner that matches a pattern associated with hiding the program guide comprises determining whether the touch event is moving along a path selected from the group of a horizontal line, a vertical line, a straight line exceeding a first threshold distance, a circle, a triangle, a square, a checkmark, and multi-touch events.

43. The non-transitory computer-readable storage medium of claim 40, wherein the stored processor-executable instructions are configured to cause the processor to perform operations such that determining whether the touch event is moving in a manner that matches a pattern associated with hiding the program guide comprises determining whether the touch event is moving in a manner that matches a user defined pattern stored in memory.

44. The non-transitory computer-readable storage medium of claim 40, wherein the stored processor-executable instructions are configured to cause the processor to perform operations such that repositioning a display of the program guide to reveal another image comprises moving the program guide to an edge of the display and displaying the other image.

45. The non-transitory computer-readable storage medium of claim 40, wherein the stored processor-executable instructions are configured to cause the processor to perform operations such that repositioning a display of the program guide to reveal another image comprises removing the program guide from the display and displaying the other image.

46. The non-transitory computer-readable storage medium of claim 40, wherein the stored processor-executable instructions are configured to cause the processor to perform operations such that the repositioning a display of the program guide to reveal another image comprises repositioning the display of the program guide to reveal a video program.

47. The non-transitory computer-readable storage medium of claim 40, wherein the stored processor-executable instructions are configured to cause the processor to perform operations further comprising determining whether a video program is playing on the electronic device, wherein repositioning a display of the program guide is accomplished only if a video program is playing and the program guide is displayed.

48. The non-transitory computer-readable storage medium of claim 40, wherein the stored processor-executable instructions are configured to cause the processor to perform operations such that repositioning a display of the program guide to reveal another image comprises:
comparing a movement distance of the touch event to a second threshold distance;
moving the program guide on the display consistent with movement of the touch event so long as the touch event movement distance does not exceed the second threshold distance; and
repositioning the display of the program guide to reveal the other image when the touch event movement distance exceeds the second threshold distance.

49. The non-transitory computer-readable storage medium of claim 40, wherein the stored processor-executable instructions are configured to cause the processor to perform operations such that repositioning a display of the program guide to reveal another image comprises animating the repositioning of the display of the program guide.

50. The non-transitory computer-readable storage medium of claim 40, wherein the stored processor-executable instructions are configured to cause the processor to perform operations such that determining whether the touch event is moving in a manner that matches a pattern associated with hiding the program guide comprises disambiguating the touch event from user input gestures associated with other program guide functionality.

51. The non-transitory computer-readable storage medium of claim 40, wherein the stored processor-executable instructions are configured to cause the processor to perform operations further comprising:
determining when the detected touch event ends; and
returning the program guide to its original position in the display when the touch event ends.

52. The non-transitory computer-readable storage medium of claim 51, wherein the stored processor-executable instructions are configured to cause the processor to perform operations such that returning the program guide to its original position in the display comprises animating movement of the program guide back to its original position in the display.
